(19) United States
(12) Patent Application Publication
(10) Pub. No.: US 2017/0239789 A1
(43) Pub. Date: Aug. 24, 2017

(54) Light Bulb Removal Assembly

(71) Applicant: Dalmiro Sian, Homewood, AL (US)

(72) Inventor: Dalmiro Sian, Homewood, AL (US)

(21) Appl. No.: 15/049,132

(22) Filed: Feb. 21, 2016

(51) Int. Cl. B25B 9/00; B25B 23/00; B25G 1/04; H01K 3/32; H01J 9/00

(52) U.S. Cl. CPC B25B 9/00; H01K 3/32; H01J 9/006; B25G 1/04; B25B 23/0028

(57) ABSTRACT

A light bulb removal assembly includes a handle that may be manipulated thereby facilitating the handle to be directed toward a light bulb. A neck is coupled to the handle.

The neck is comprised of a bendable material. Thus, the neck is positionable at a selected angle with respect to the handle. A cup is coupled to the neck and the cup frictionally engages the light bulb when the handle is directed toward the light bulb. The cup rotates when the handle is manipulated. Thus, the cup removes the light bulb from a socket.

### BACKGROUND OF THE DISCLOSURE

### Field of the Disclosure

The disclosure relates to removal devices and more particularly pertains to a new removal device for removing a light bulb from a socket.

### SUMMARY OF THE DISCLOSURE

An embodiment of the disclosure meets the needs presented above by generally comprising a handle. The handle may be manipulated thereby facilitating the handle to be directed toward a light bulb. A neck is coupled to the handle. The neck is comprised of a bendable material. Thus, the neck is positionable at a selected angle with respect to the handle. A cup is coupled to the neck and the cup frictionally engages the light bulb when the handle is directed toward the light bulb. The cup rotates when the handle is manipulated. Thus, the cup removes the light bulb from a socket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a light bulb removal assembly according to an embodiment of the disclosure.

FIG. 2 is an exploded perspective view of an embodiment of the disclosure.

FIG. 3 is a perspective in-use view of an embodiment of the disclosure.

FIG. 4 is a cross sectional view taken along line 4-4 of FIG. 1 of an embodiment of the disclosure.

FIG. 5 is a top phantom view of an embodiment of the disclosure.

### DESCRIPTION OF THE PREFERRED EMBODIMENT

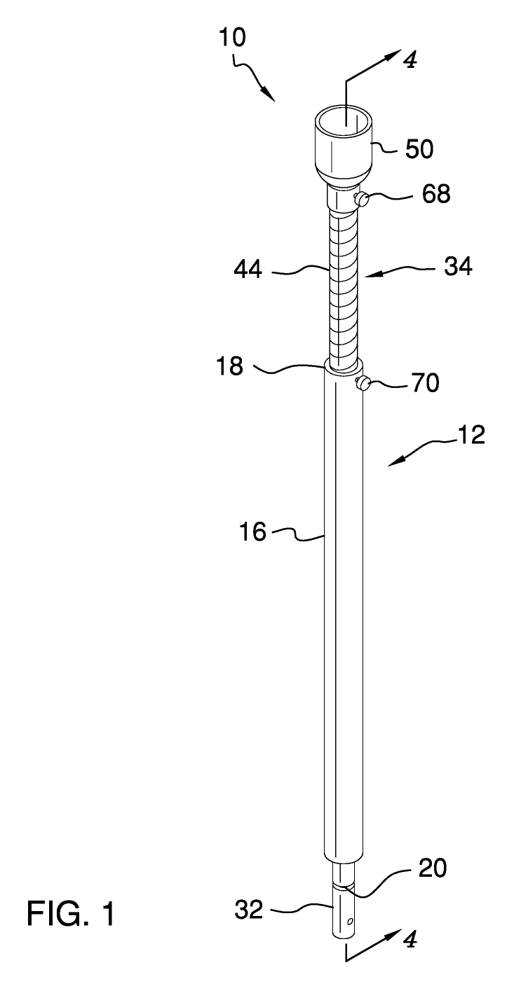

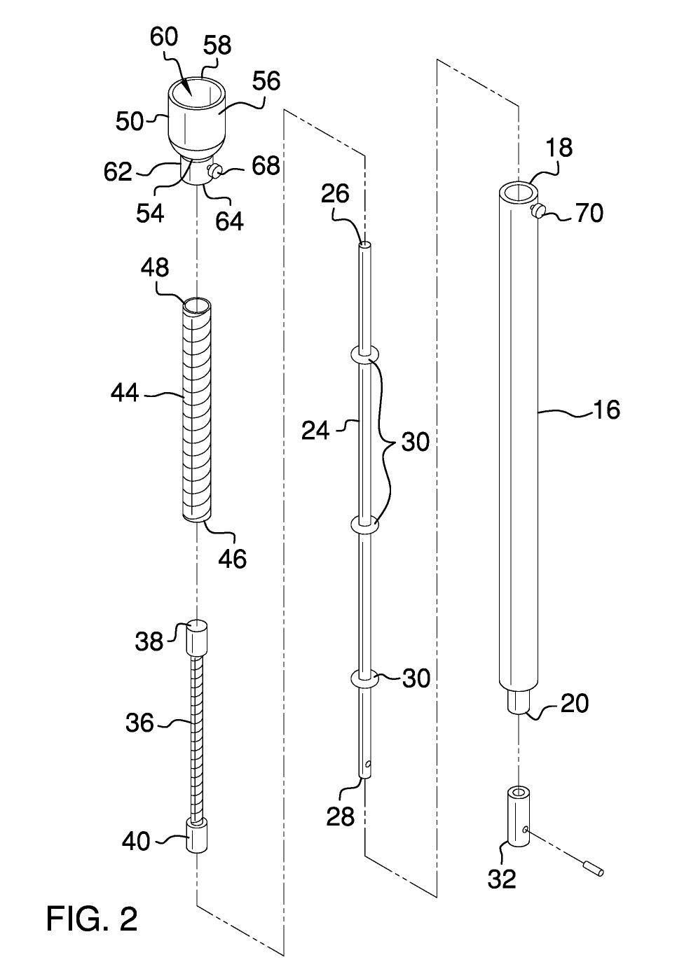

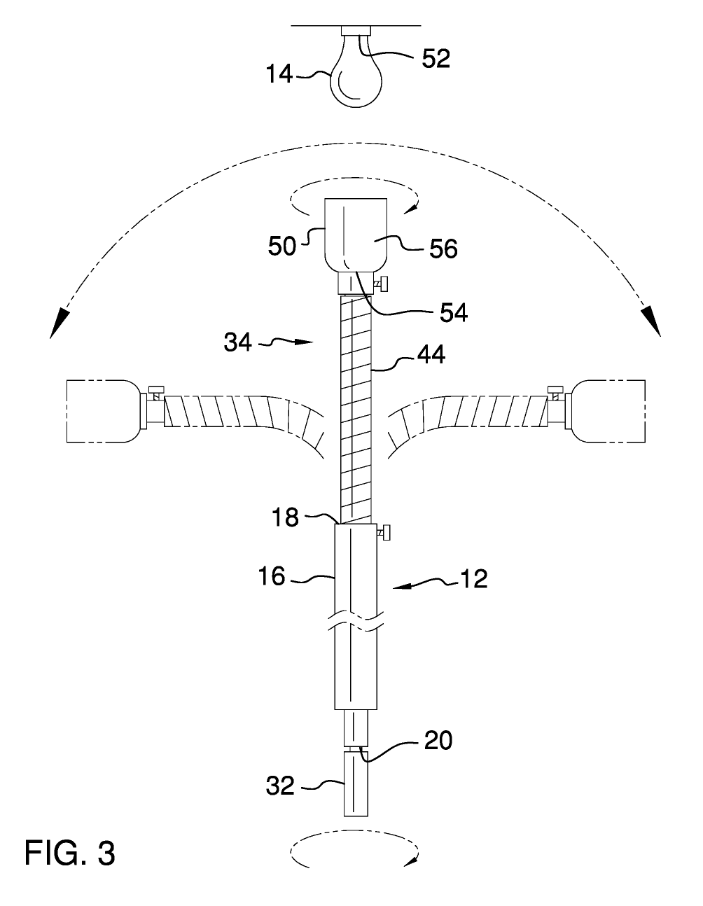

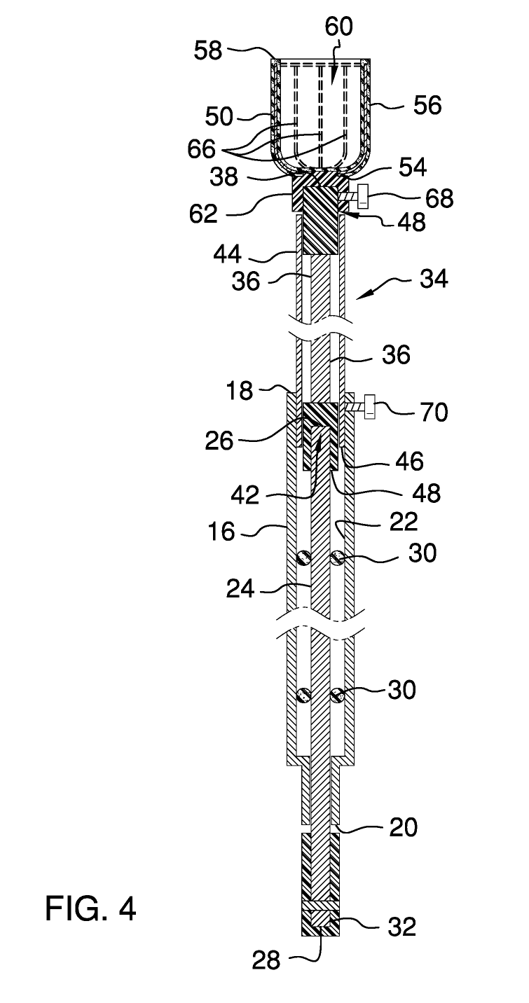

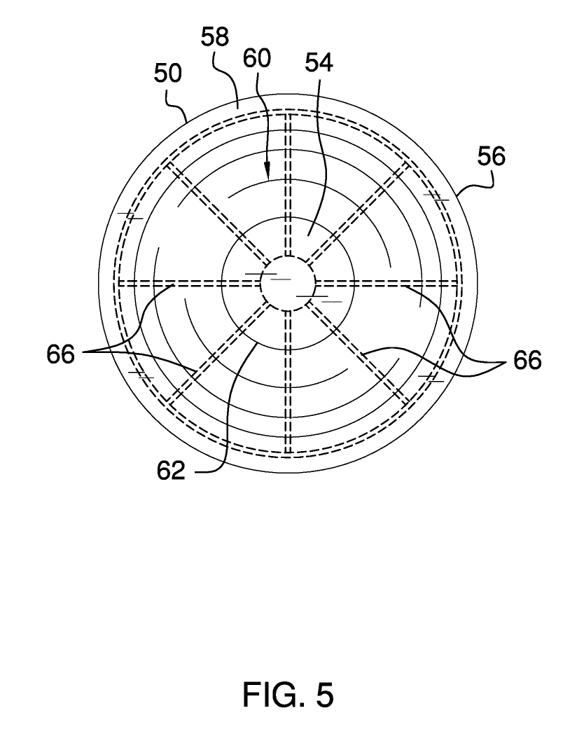

With reference now to the drawings, and in particular to FIGS. 1 through 5 thereof, a new removal device embodying the principles and concepts of an embodiment of the disclosure and generally designated by the reference numeral 10 will be described.

As best illustrated in FIGS. 1 through 5, the light bulb removal assembly 10 generally comprises a handle 12 that may be manipulated thereby facilitating the handle 12 to be directed toward a light bulb 14. The light bulb 14 may be an incandescent light bulb or a fluorescent light bulb. The handle 12 comprises a first sleeve 16 that has a first end 18, a second end 20 and an inner surface 22. The first sleeve 16 may be gripped. The light bulb 14 may be positioned on a ceiling or the like such that the light bulb 14 is inaccessible from a floor.

A first rod 24 is provided that has an upper end 26 and a lower end 28. The first rod 24 is movably positioned within the first sleeve 16. Thus, the first rod 24 may be rotated within the first sleeve 16. The first rod 24 extends outwardly from the second end 20 of the first sleeve 16.

A plurality of rings 30 is provided and each of the rings 30 is positioned around the first rod 24. The rings 30 are spaced apart from each other and are distributed along the first rod 24. Each of the rings 30 frictionally engages the inner surface 22 of the first sleeve 16 such that the first rod 24 is centrally positioned within the first sleeve 16. A knob 32 is coupled to the lower end 28 of the first rod 24 and the knob 32 may be manipulated. The knob 32 rotates the first rod 24 within the first sleeve 16 when the knob 32 is manipulated.

A neck 34 is provided. The neck 34 is coupled to and extends upwardly from the handle 12. The neck 34 is comprised of a bendable material. Thus, the neck 34 is positionable at a selected angle with respect to the handle 12. The neck 34 facilitates the light bulb 14 to be removed from a wall or the like.

The neck 34 comprises a second rod 36 that has a top end 38 and a bottom end 40. The bottom end 40 has a well 42 extending upwardly toward the top end 38. The second rod 36 is substantially comprised of a resiliently flexible material. The well 42 insertably receives the upper end 26 of the first rod 24 such that the second rod 36 extends outwardly from the first end 18 of the first sleeve 16. The second rod 36 may comprise a bendable, coiled wire or the like.

A second sleeve 44 is provided that has a primary end 46 and a secondary end 48. The primary end 46 is directed into the first end 18 of the first sleeve 16. Thus, the second rod 36 extends outwardly from the secondary end 48. The second sleeve 44 is comprised of a resiliently flexible material. The second sleeve 44 may comprise a coiled gooseneck sleeve or the like. The top end 38 of the second rod 36 is positionable at a selected angle with respect to the second end 20 of the first sleeve 16. The top end 38 of the second rod 36 is retained at the selected angle.

A cup 50 is coupled to the neck 34 and the cup 50 may frictionally engage the light bulb 14 when the handle 12 is directed toward the light bulb 14. The cup 50 rotates when the handle 12 is manipulated. Thus, the cup 50 may remove the light bulb 14 from a socket 52. The cup 50 has a bottom wall 54 and an outer wall 56 extending upwardly from the bottom wall 54. The outer wall 56 has a distal end 58 with respect to the bottom wall 54. The distal end 58 forms an opening 60 into the cup 50. The cup 50 is comprised of a resiliently compressible material such as rubber or the like.

A receiver 62 extends downwardly from the bottom wall 54 of the cup 50. The receiver 62 has a distal end 64 with respect to the bottom wall 54. The distal end 64 of the receiver 62 is open. The receiver 62 insertably receives the top end 38 of the second rod 36 such that the cup 50 rotates when the knob 32 is rotated. A plurality of wires 66 is provided and each of the wires 66 is positioned within the outer wall 56 of the cup 50. The wires 66 are spaced apart from each other and distributed around the cup 50. Thus, the wires 66 urge the cup 50 to frictionally engage the light bulb 14.

A first screw 68 is provided. The first screw 68 extends through the receiver 62 and engages the second rod 36. Thus, the cup 50 is removably retained on the second rod 36. A second screw 70 is provided. The second screw 70 extends through the first sleeve 16 and engages the second sleeve 44. Thus, the second sleeve 44 is removably coupled to the first sleeve 16. The second screw 70 may be positioned proximate the first end of the first sleeve 16.

In use, the cup 50 is manipulated to position the cup 50 at a selected angle with respect to the first sleeve 16. The handle 12 is manipulated such that the cup 50 frictionally engages the light bulb 14. The knob 32 is manipulated to rotate the cup 50. Thus, the cup 50 threadably removes the light bulb 14 from the socket 52. The cup 50 captures fragments of the light blub 14 if the light bulb 14 shatters while the light bulb 14 is being removed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light bulb removal assembly comprising:
a handle being configured to be manipulated thereby facilitating said handle to be directed toward a light bulb;
a neck being coupled to said handle, said neck being comprised of a bendable material such that said neck is positionable at a selected angle with respect to said handle; and
a cup being coupled to said neck wherein said cup is configured to frictionally engage the light bulb when said handle is directed toward the light bulb, said cup rotating when said handle is manipulated wherein said cup is configured to remove the light bulb from a socket, said cup being comprised of a resiliently compressible material.

2. The assembly according to claim 1, wherein said handle comprises a first sleeve having a first end, a second end and an inner surface, said first sleeve being configured to be gripped.

3. The assembly according to claim 2, further comprising a first rod having an upper end and a lower end, said first rod being movably positioned within said first sleeve wherein said first rod is configured to be rotated within said first sleeve, said first rod extending outwardly from said second end of said first sleeve.

4. The assembly according to claim 3, further comprising a plurality of rings, each of said rings being positioned around said first rod, said rings being spaced apart from each other and being distributed along said first rod, each of said rings frictionally engaging said inner surface of said first sleeve such that said first rod is centrally positioned within said first sleeve.

5. The assembly according to claim 3, further comprising a knob being coupled to said lower end of said first rod wherein said knob is configured to be manipulated, said knob rotating said first rod within said first sleeve when said knob is manipulated.

6. The assembly according to claim 1, wherein:
said handle includes:
a first rod having an upper end; and
a first sleeve having a first end; and
said neck comprises a second rod having a top end and a bottom end, said bottom end having a well extending upwardly toward said top end, said second rod being substantially comprised of a resiliently flexible material, said well insertably receiving said upper end of said first rod such that said second rod extends outwardly from said first end of said first sleeve.

7. The assembly according to claim 6, wherein said cup has a bottom wall and an outer wall extending upwardly from said bottom wall, said outer wall having a distal end with respect to said bottom wall, said distal end forming an opening into said cup, said cup having a receiver extending downwardly from said bottom wall, said receiver being open, said receiver insertably receiving said top end of said second rod such that said cup rotates when said knob is rotated.

8. The assembly according to claim 7, further comprising a plurality of wires, each of said wires being positioned within said outer wall of said cup wherein said wires are configured to urge said cup to frictionally engage the light bulb.

9. A light bulb removal assembly comprising:
a handle being configured to be manipulated thereby facilitating said handle to be directed toward a light bulb, said handle comprising:
a first sleeve having a first end, a second end and an inner surface, said first sleeve being configured to be gripped,
a first rod having an upper end and a lower end, said first rod being movably positioned within said first sleeve wherein said first rod is configured to be rotated within said first sleeve, said first rod extending outwardly from said second end of said first sleeve,
a plurality of rings, each of said rings being positioned around said first rod, said rings being spaced apart from each other and being distributed along said first rod, each of said rings frictionally engaging said inner surface of said first sleeve such that said first rod is centrally positioned within said first sleeve, and
a knob being coupled to said lower end of said first rod wherein said knob is configured to be manipulated, said knob rotating said first rod within said first sleeve when said knob is manipulated;
a neck being coupled to said handle, said neck being comprised of a bendable material such that said neck is positionable at a selected angle with respect to said handle, said neck comprising:
a second rod having a top end and a bottom end, said bottom end having a well extending upwardly toward said top end, said second rod being substantially comprised of a resiliently flexible material, said well insertably receiving said upper end of said first rod such that said second rod extends outwardly from said first end of said first sleeve, and
a second sleeve having a primary end and a secondary end, said primary end being directed into said first end of said first sleeve such that said second rod extends outwardly from said secondary end, said second sleeve being comprised of a resiliently flexible material; and
a cup being coupled to said neck wherein said cup is configured to frictionally engage the light bulb when said handle is directed toward the light bulb, said cup rotating when said handle is manipulated wherein said cup is configured to remove the light bulb from a socket, said cup being comprised of a resiliently compressible material, said cup having a bottom wall and an outer wall extending upwardly from said bottom wall, said outer wall having a distal end with respect to said bottom wall, said distal end forming an opening into said cup, said cup having a receiver extending downwardly from said bottom wall, said receiver being open, said receiver insertably receiving said top end of said second rod such that said cup rotates when said knob is rotated; and
a plurality of wires, each of said wires being positioned within said outer wall of said cup wherein said wires are configured to urge said cup to frictionally engage the light bulb.
